(19) United States
(12) Patent Application Publication
(10) Pub. No.: US 2005/0281568 A1
(43) Pub. Date: Dec. 22, 2005

(54) Image forming apparatus, image forming method and image forming program

(75) Inventor: Yusuke Hashizume, Urayasu-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/867,764

(22) Filed: Jun. 16, 2004

(51) Int. Cl. G03G 15/08

(52) U.S. Cl. 399/27; 399/227

(57) ABSTRACT

A multicolor image forming apparatus is provided which is capable of suppressing rotational vibrations caused by a rotary unit thereby to carry out the formation of images of excellent quality even if the amount of remaining toner in the rotary unit changes. In the multicolor image forming apparatus (10), accelerations, uniform speeds and decelerations, which do not cause residual vibration of the rotary unit due to overshooting when the rotary unit (11) is changed from its acceleration rotation to its uniform rotation or vice versa, are stored in an acceleration and acceleration storage section (16) in correspondence to the amounts of toners held by the developing units. A rotary unit rotation control section (17) detects the amounts of remaining toners of the developing units through a toner amount detection section at each timing when the rotary unit is driven to rotate for development, reads out an acceleration, a uniform speed and a deceleration corresponding to the detected amounts of remaining toners from the acceleration and deceleration storage section, and controls the rotational movement of the rotary unit according to the result thus read out. Accordingly, the rotary unit does not generate residual vibration upon switching of its rotation.

### BACKGROUND OF THE INVENTION

1. Field of the Invention

The present invention relates to an image forming apparatus or the like, and more particularly, it relates to an image forming apparatus (hereinafter referred to as a multicolor image forming apparatus), an image formation method and an image formation program for driving a rotary unit with developing units for respective colors mounted thereon to rotate in an accelerating, a uniform and a decelerating speed, and sequentially stopping the developing units at a position of development to perform development.

2. Description of the Related Art

In the past, though such a kind of multicolor image forming apparatus can be constructed in accordance with a variety of systems, it is common in these systems that the colors of an original picture image are separated into three colors, i.e., yellow, magenta and cyan, or four colors, i.e., these three colors plus black, and an electrostatic latent image of each of these colors is formed on a photosensitive member, and developed by a toner corresponding to each color. In order to execute these multicolor image forming processes, it is necessary to dispose developing units in proximity to the photosensitive member. In this case, there are two systems, one being constructed such that all the developing units for the respective colors are disposed in proximity to the photosensitive member, the other being constructed such that the developing units for the respective colors are driven to sequentially move toward the photosensitive member by using a developing unit switching means.

The above-mentioned developing unit switching means includes a slide mount type one, a rotary unit type one, etc., and in general, there are employed a lot of developing unit switching means of the rotary unit type. According to the configuration of the developing unit switching means of this rotary unit type, a control device for controlling switching between developing units is complicated in structure, but the sizes of the developing units and the entire multicolor image forming apparatus can be reduced as compared with such a configuration that developing units for respective colors are arranged along the outer periphery of a photosensitive member. In addition, there are multicolor image forming apparatuses in which an exchangeable process cartridge is adopted so as to avoid trouble and inconvenience accompanying the replenishment of toners. In this case, the costs can be reduced by sharing the structures of the developing units.

In order to form full color images by such developing units, it is necessary to execute processes of superimposing color-separated images, which processes vary depending on the systems employed, of which three as enumerated below are particularly known. That is,

(1) A first system is to superimpose color-separated images directly on a photosensitive member one over another, and to transfer the thus superimposed images onto a transfer material (e.g., printing paper) in a lump.

(2) A second system is to wrap a transfer material on a transfer drum, and to sequentially superimpose color-separated images on a photosensitive member onto the transfer material one over another.

(3) A third system is to use a drum-shaped or belt-shaped intermediate transfer member, to superimpose color-separated images on a photosensitive member onto the intermediate transfer member one over another, and to transfer the thus superimposed color-separated images to a transfer material in a lump.

The known multicolor image forming apparatus of the rotary unit type is controlled as follows. In case where the rotary unit is driven to rotate, the rotational speed of the rotary unit is first increased at a prescribed fixed acceleration, and then kept constant at a predetermined rotational speed when it reaches the predetermined rotational speed, and thereafter decreased at a fixed deceleration, so that the rotary unit is thereby stopped at a specified position. Under such known control, the acceleration by which the rotary unit is driven to rotate is not changed even if the amount of remaining toners changes. Therefore, when the amount of remaining toners is controlled to meet or suit the acceleration, the rotational speed of the rotary unit is gently switched from acceleration rotation to uniform rotation, as shown in curve “P” in FIG. 7, but when the amount of remaining toners is not suited to the acceleration, the rotational speed of the rotary unit causes vibration due to overshooting at the time of switching from the acceleration rotation to the uniform rotation, as shown in curve “Q” in FIG. 7.

Accordingly, for example, as shown in FIG. 8, in a multicolor image forming apparatus 50 that is provided with a rotary unit 51 and an optical reading system 52, a vibration isolation member 53 is arranged between the rotary unit 51 and the optical reading system 52, so that even if vibration is generated in the rotary unit 51, the resultant influence is prevented from transmitting to the optical reading system 52 so much. However, even with such a measure, there will take place a change in the natural frequency of the rotary unit depending upon a change in the amount of remaining toners, so vibrations of frequencies other than those which can be isolated by the vibration isolation member 53 might be generated. As a result, vibrations due to overshooting cannot be completely insulated, so the vibrations of CCD elements, a carriage, etc., in the optical reading system 52 might be caused, thus finally generating trouble in the readout images.

### SUMMARY OF THE INVENTION

Accordingly, the present invention has been made to solve the problems as referred to above, and has for its object to provide an image forming apparatus which is capable of suppressing rotational vibrations caused by a rotary unit thereby to carry out the formation of images of excellent quality even if the amount of remaining toners in the rotary unit changes.

In order to achieve the above-mentioned object, according to one aspect of the present invention, there is provided a multicolor image forming apparatus for driving a rotary unit with developing units for respective colors mounted thereon to rotate so as to sequentially stop the respective developing units at a position of development to perform development, the apparatus comprising: a rotation control mode storage section that stores, in correspondence to the amounts of toners held by the developing units, rotation control modes capable of preventing the generation of vibration of the rotary unit when the state of the rotational movement of the rotary unit is switched; a toner amount detection section that detects an amount of toner held by each of the developing units; and a rotation control section that reads out from the rotation control mode storage section a rotation control mode of the rotary unit stored corresponding to the amounts of toners which are held by the developing units and detected by the toner amount detection section, and controls the rotation of the rotary unit according to the rotation control mode thus read out.

According to another aspect of the present invention, there is provided an image forming method for an image forming apparatus for driving a rotary unit with developing units for respective colors mounted thereon to rotate so as to sequentially stop the respective developing units at a position of development to perform development, the method comprising the step of: storing, in correspondence to the amounts of toners held by the developing units, rotation control modes capable of preventing the generation of vibration of the rotary unit when the state of the rotational movement of the rotary unit is switched; detecting the amounts of toners held by the developing units when the state of the rotational movement of the rotary unit is switched; and controlling the rotation of the rotary unit in accordance with a rotation control mode of the rotary unit stored corresponding to the amounts of toners held by the developing units thus detected.

According to a further aspect of the present invention, there is provided an image forming program for an image forming apparatus which can make a computer execute the above-mentioned image forming method.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a view showing the construction of an image reading apparatus according to the present invention.

FIG. 2 is a cross sectional view showing a rotary unit of FIG. 1 in detail.

FIG. 3 is a flow chart explaining an exemplary operation of the multicolor image forming apparatus shown in FIG. 1.

FIG. 4 is a view explaining an acceleration during acceleration rotation and a shift from acceleration rotation to uniform rotation with reference to the control operation shown in FIG. 3.

FIG. 5(A) is a view showing the entire control operation according to a first control type TPA shown in FIG. 3 and FIG. 4.

FIG. 5(B) is a view showing the entire control operation according to a second control type TPB shown in FIG. 3 and FIG. 4.

FIG. 5(C) is a view showing the entire control operation according to a third control type TPC shown in FIG. 3 and FIG. 4.

FIGS. 6(A) and 6(B) are views for explaining the principle that supports the determinations of the respective control types shown in FIG. 3 and FIG. 4.

FIG. 7 is a view explaining overshooting generated when the rotary unit of the multicolor image forming apparatus is controlled to rotate according to a known control method.

FIG. 8 is a view explaining how the overshooting shown in FIG. 7 exerts an adverse influence on the multicolor image forming apparatus.

### DESCRIPTION OF THE PREFERRED EMBODIMENTS

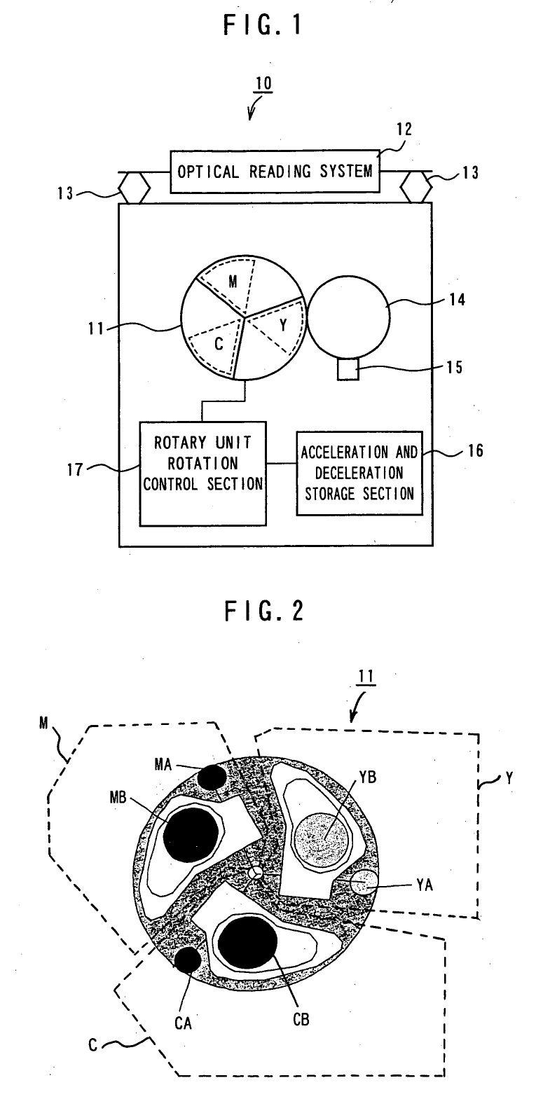

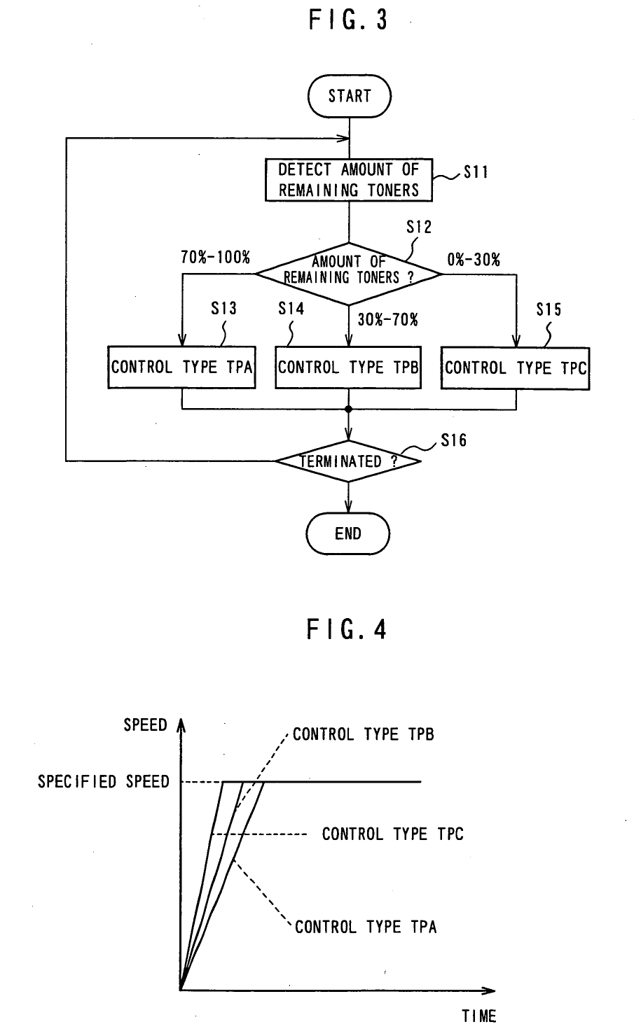

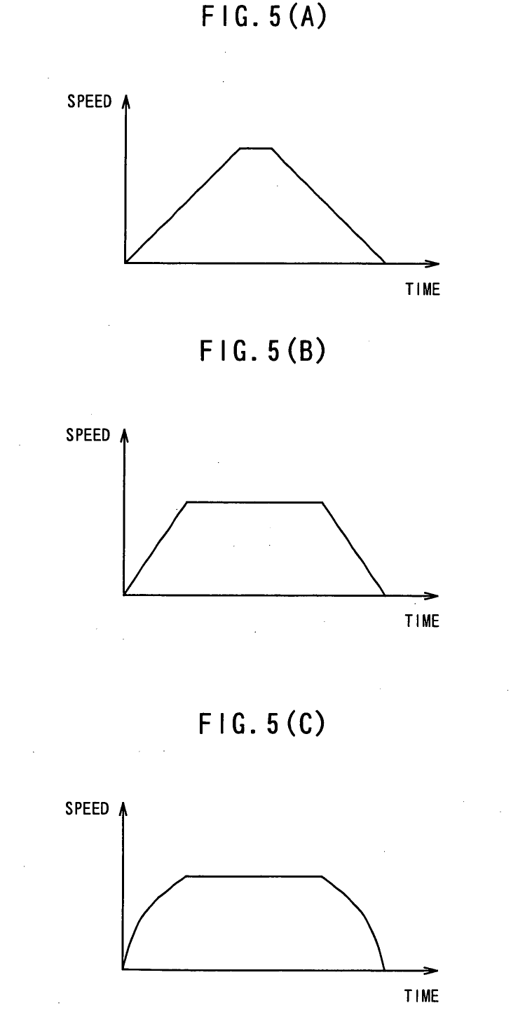

Hereinafter, a preferred embodiment of the present invention will be described in detail while referring to the accompanying drawings. FIG. 1 is a view that illustrates the construction of an image forming apparatus according to the present invention. FIG. 2 is a cross sectional view that illustrates a rotary unit of FIG. 1 in detail. FIG. 3 is a flow chart that explains an exemplary operation of the multicolor image forming apparatus illustrated in FIG. 1. FIG. 4 is a view that explains an acceleration during acceleration rotation and a shift from acceleration rotation to uniform rotation with reference to the control operation shown in FIG. 3. FIGS. 5(A) through 5(C) are views that illustrate three examples of the control operation according to three control types (corresponding to the respective rotation control modes of the present invention), as illustrated in FIG. 3 and FIG. 4.

A multicolor image forming apparatus 10 illustrated in FIG. 1 includes a rotary unit 11, an optical reading system 12, a vibration isolation member 13, a photosensitive drum 14, a black developing unit 15, an acceleration and deceleration storage section (i.e., a rotation control mode storage section of the present invention) 16, and a rotary unit rotation control section (i.e., a rotation control section of the present invention) 17. The rotary unit 11 has a yellow developing unit Y, a magenta developing unit M and a cyan developing unit C installed thereon. In addition, as shown in FIG. 2, the yellow developing unit Y is provided with a yellow developer YA and a yellow toner bottle YB, and the magenta developing unit M is provided with a magenta developer MA and a magenta toner bottle MB, and a cyan developing unit C is provided with a cyan developer CA and a cyan toner bottle CB.

In this case, each of the yellow toner bottle YB, the magenta toner bottle MB and the cyan toner bottle CB is formed as a detachable process cartridge. Also, the multicolor image forming apparatus 10 is provided with a remaining toner amount detection section (not shown) for detecting the amount of remaining toner in each of the developing units Y, M, and C. This remaining toner amount detection section may comprise, for example, a hardware sensor such as a transparency sensor or the like for detecting the amount of each remaining toner in a hardware manner, or a software sensor such as one for detecting the amount of each remaining toner in a software manner by calculating the amount of each toner consumed from a total amount of areas printed on printing paper.

Accelerations, uniform speeds and decelerations, which do not cause vibration of the rotary unit 11 due to overshooting (residual vibration) when the rotary unit 1 is changed from its acceleration rotation to its uniform rotation or its uniform rotation to its deceleration rotation, are stored in the acceleration and acceleration storage section 16 in correspondence to the amounts of toners held by the developing units Y, M and C, respectively, or a total sum thereof. The rotary unit rotation control section 17 receives the amounts of toners (the amounts of remaining toners) held by the developing units Y, M and C, respectively, that are detected by the remaining toner amount detection section, reads out an acceleration, a uniform speed and a deceleration of the rotary unit 11, which are stored in correspondence to the amounts of the toners thus received, from the acceleration and deceleration storage section 16, and drives the rotary unit 11 to move at the acceleration, the uniform speed and the deceleration thus read out. The rotary unit rotation control section 17 drives the developers YA, MA and CA of the developing units Y, M and C to rotatingly move so that the developers are sequentially stopped at the position of development to carry out development in cooperation with the photosensitive drum 14.

Now, reference will be made to a concrete example of the control operation of the rotary unit rotation control section 17 while referring to FIGS. 3 through 5. The rotary unit rotation control section 17 receives the detection result of the toner amount detection section at each timing when the rotary unit 11 is driven to rotate for development. The amounts of remaining toners YR, MR and CR of the respective developing units Y, M and C are detected from the thus received result (S11). The rotary unit rotation control section 17 calculates, based on the amounts of remaining toners YR, MR and CR detected by the toner amount detection section, a total amount or sum TR thereof, and makes a determination as to what percentage the total sum TR is, in comparison with the total sum of toners in their fully filled states (S12).

When the total sum of toners TR is determined as 70%<TR≦100% in step S12, it is recognized that the rotary unit 11 does not generate vibration due to overshooting (residual vibration) at the time when it is switched from acceleration rotation to uniform rotation, and an acceleration and a specified speed stored in the acceleration and deceleration storage section 16, i.e., an acceleration of 5,000 mm/sec² and a specified speed of 210 mm/sec according to a first control type TPA shown in FIG. 4, are read out. Thus, the rotary unit 11 is driven to acceleratingly rotate at the acceleration thus read out, and when the specified speed is reached, the rotary unit 11 is controlled to perform uniform rotation at the specified speed through a prescribed first angular range. Thereafter, the rotary unit 11 is controlled to deceleratingly rotate at a deceleration of the same absolute value as that of the acceleration. For example, the developer YA is caused to stop at the position of development (see FIG. 5(A) for entire control) so as to perform the development of yellow (S13).

When the total sum of toners TR is determined as 30%<TR≦70% in step S12, an acceleration (e.g., 8,000 mm/sec²) and a specified speed (e.g., 210 mm/sec) stored in the acceleration and deceleration storage section 16 according to a second control type TPB in FIG. 4 are read out, so that the rotary unit 11 is driven to acceleratingly rotate at the acceleration thus read out. When the specified speed is reached, the rotary unit 11 is controlled to perform uniform rotation at the specified speed for a prescribed angular range, and then, the rotary unit 11 is controlled to deceleratingly rotate at a deceleration of the same absolute value as that of the acceleration, whereby the developer MA, for example, is caused to stop at the position of development (see FIG. 5(B)) so as to perform the development of magenta (S14).

Similarly, when the total sum of toners TR is determined as 0%<TR≦30% in step S12, an acceleration of 10,000 mm/sec² and a specified speed of 210 mm/sec stored in the acceleration and deceleration storage section 16 according to a third control type TPC in FIG. 4 are read out, so that the rotary unit 11 is driven to acceleratingly rotate at the acceleration thus read out. When the specified speed is reached, the rotary unit 11 is controlled to perform uniform rotation at the specified speed for a prescribed angular range, and then, the rotary unit 11 is controlled to deceleratingly rotate at a deceleration of the same absolute value as that of the acceleration, whereby the developer CA, for example, is caused to stop at the position of development (see FIG. 5(C)) so as to perform the development of cyan (S15). When the control in either one of step S13 through step S15 is completed, the rotary unit rotation control section 17 makes a determination as to whether the control of the rotational movement of the rotary unit 11 should be terminated. If a positive determination is made, the control of the rotational movement of the rotary unit 11 is terminated, whereas if it is determined otherwise, a return is performed to step S11 where the next timing for the rotational movement of the rotary unit 11 is awaited.

By storing an image forming program including the processes of such steps S11 through S16 in a recording medium that can be read by a computer, it is possible to make the computer execute an image forming method using the image forming apparatus according to the present invention. Here, note that in the present invention, the computer readable recording medium may be any type or form of recording medium such as a ROM (Read Only Memory), which can store the program and can be read by the image forming apparatus. In addition, the functions to be obtained by such preinstallation or downloading can be achieved through cooperation with an OS (operating system) or the like in the interior of the apparatus.

Although in the embodiment of the present invention, there has been described the case where functions to achieve the invention are prerecorded in the interior of the apparatus, the present invention is not limited to this but similar functions can be downloaded into the apparatus via a network. Alternatively, a recording medium storing therein similar functions can be installed in the apparatus.

Although in the above description, it has been explained for selection of the control types shown in FIG. 4 that a control type (i.e., acceleration in this case) is selected which is recognized not to generate vibration (residual vibration) of the rotary unit 11 due to overshooting upon switching from acceleration or deceleration rotation to uniform rotation, the setting of an appropriate control type corresponding to the amount of remaining toners can be decided even by actual experiments, etc. In that case, as shown in FIG. 4, too, it is preferable that the acceleration be decreased in accordance with the increasing amount of remaining toners. The values for appropriate acceleration, uniform speed and deceleration corresponding to the values for the amount of remaining toners are stored in advance in the acceleration and deceleration storage section 16. Here, note that a guideline for such experiments is as follows. That is, in general, it is possible to suppress vibration of a mechanical system upon rising or starting of its motion by accelerating it at an acceleration that does not include the resonance frequency of the mechanical system. An optimal acceleration capable of suppressing such rising or starting vibration can be calculated as follows.

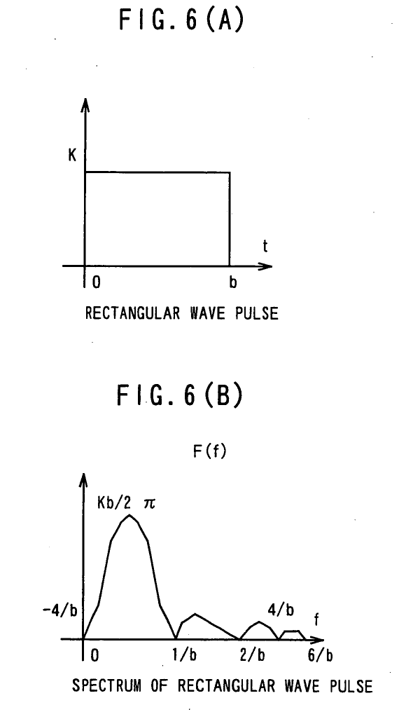

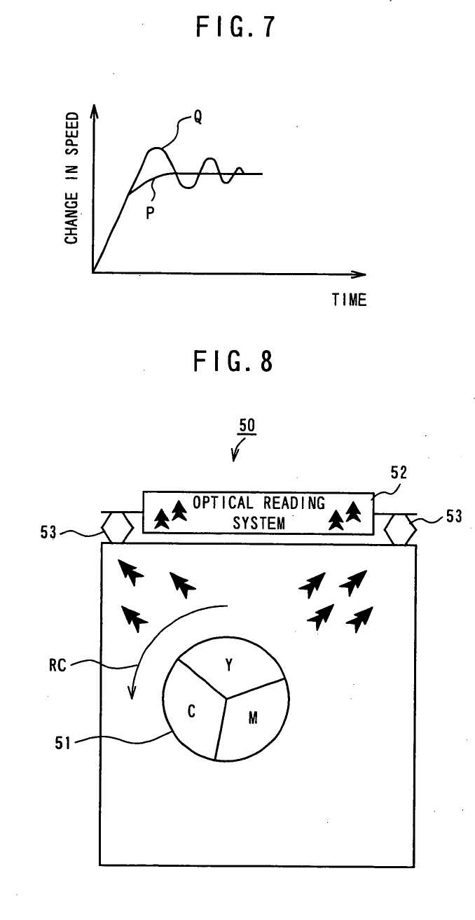

When it is assumed that the acceleration of the mechanical system is represented by K, and the width or duration of the acceleration time is represented by b, as shown by a rectangular wave pulse in FIG. 6(A), the frequency component of the rectangular wave pulse becomes like shown by a spectrum thereof in FIG. 6(B). Accordingly, in order to make zero the frequency component of the rectangular wave pulse at the resonance frequency of the mechanical system, 1/b and b take the following values for the respective control types, as shown in Table 1 below. That is,

TABLE 1

| | Control type TPA | Control type TPB | Control type TPC |
|---|---|---|---|
| 1/b | 23.8 | 38.1 | 47.6 |
| b | 0.420 | 0.0262 | 0.0210 |

Accordingly, assuming that an initial speed according to the self-activation frequency is 0 mm/sec and a target speed is 210 mm/sec, accelerations in accordance with the control types become as follows.

(1) Control type TPA (210−0)/0.0420=5,000 mm/sec²

(2) Control type TPB (210−0)/0.0262=8,000 mm/sec²

(3) Control type TPC (210−0)/0.0210=10,000 mm/sec².

In the above-mentioned example, the control types have been classified into three, but needless to say, they can be classified into more than three. In addition, though the control types are set according to the total sum TR of the amounts of remaining toners in the respective developing units, the control types can be set according to the states (or combinations) of the amounts of remaining toners in the respective developing units instead of the total sum TR of the amounts of remaining toners. For example, the control types may be set according to the respective states of remaining toners such as an amount of remaining yellow tuner of 30%, an amount of remaining magenta toner of 80%, and an amount of remaining cyan toner 70%, or the like. Thus, when the rotary unit is driven to rotate, the rotary unit rotation control section 17 serves to control the rotary unit in such a manner that no or extremely limited residual vibration can be generated. As a result, unnecessary vibration can not be given to the optical reading system 12 or the like, and hence it is possible to provide excellent image formation.

As described above, in this embodiment of the present invention, accelerations, uniform speeds and decelerations, which do not cause residual vibration in the form of vibration of a rotary unit due to overshooting when the rotation of the rotary unit is changed from its acceleration rotation to its uniform rotation or its uniform rotation to its deceleration rotation, are stored in an acceleration and acceleration storage section according to the amounts of toners held by the developing units. Accordingly, a rotary unit rotation control section receives the detection result of the toner amount detection section, and detects the amounts of remaining toners held by the developing units at each timing when the rotary unit is driven to rotate for development. Then, the rotary unit rotation control section reads out an acceleration, a uniform speed and a deceleration corresponding to the detected amounts of remaining toners from the acceleration and deceleration storage section, so that it can control the rotational movement of the rotary unit according to the result thus read out. Accordingly, the rotary unit does not generate residual vibration upon switching of the rotation thereof.

As described in detail above, according to this embodiment of the present invention, even if the amount of remaining toners in the rotary unit changes, the rotation control section controls the rotation of the rotary unit according to a rotation control mode (i.e., acceleration, uniform speed and deceleration) suited to the changed amount of remaining toners. As a result, the rotational vibration generated by the rotary unit can be suppressed, thus making it possible to form images of excellent quality.

While the invention has been described in terms of a preferred embodiment, those skilled in the art will recognize that the invention can be practiced with modifications within the spirit and scope of the appended claims.

1. An image forming apparatus for driving a rotary unit with developing units for respective colors mounted thereon to rotate so as to sequentially stop said respective developing units at a position of development to perform development,
said apparatus comprising:
a rotation control mode storage section that stores, in correspondence to the amounts of toners held by said developing units, rotation control modes capable of preventing the generation of vibration of said rotary unit when the state of the rotational movement of said rotary unit is switched;
a toner amount detection section that detects an amount of toner held by each of said developing units; and
a rotation control section that reads out from said rotation control mode storage section a rotation control mode of said rotary unit stored corresponding to the amounts of toners which are held by said developing units and detected by said toner amount detection section, and controls the rotation of said rotary unit according to the rotation control mode thus read out.

2. The image forming apparatus as set forth in claim 1, wherein when said rotary unit is switched from acceleration rotation to uniform rotation, said rotation control section reads out said rotation control mode from said rotation control mode storage section, and controls the rotation of said rotary unit according to the rotation control mode thus read out.

3. The image forming apparatus as set forth in claim 1, wherein when said rotary unit is switched from uniform rotation to deceleration rotation, said rotation control section reads out said rotation control mode from said rotation control mode storage section, and controls the rotation of said rotary unit according to the rotation control mode thus read out.

4. The image forming apparatus as set forth in claim 1, wherein said rotation control modes stored in said rotation control mode storage section include at least either one of an acceleration, a uniform speed and a deceleration.

5. The image forming apparatus as set forth in claim 1, wherein said rotation control modes stored in said rotation control mode storage section are stored in correspondence to the amounts of toners held by said developing units, respectively.

6. The image forming apparatus as set forth in claim 1, wherein said rotation control modes stored in said rotation control mode storage section are stored in correspondence to a total sum of the amounts of toners held by said developing units, respectively.

7. The image forming apparatus as set forth in claim 1, wherein accelerations and decelerations stored in said rotation control mode storage section as said rotation control modes are stored as values of the same magnitude.

8. An image forming method for an image forming apparatus for driving a rotary unit with developing units for respective colors mounted thereon to rotate so as to sequentially stop said respective developing units at a position of development to perform development, said method comprising the step of:
storing, in correspondence to the amounts of toners held by said developing units, rotation control modes capable of preventing the generation of vibration of said rotary unit when the state of the rotational movement of said rotary unit is switched;
detecting the amounts of toners held by said developing units when the state of the rotational movement of said rotary unit is switched; and
controlling the rotation of said rotary unit in accordance with a rotation control mode of said rotary unit stored corresponding to the amounts of toners held by said developing units thus detected.

9. The image forming method for an image forming apparatus as set forth in claim 8, further comprising the steps of:
storing, in correspondence to the amounts of toners held by said developing units, rotation control modes capable of preventing the generation of vibration of said rotary unit when said rotary unit is switched from acceleration rotation to uniform rotation;
detecting the amounts of toners held by said developing units when said rotary unit is switched from acceleration rotation to uniform rotation; and
controlling the rotation of said rotary unit in accordance with a rotation control mode of said rotary unit stored corresponding to the amounts of toners held by said developing units thus detected.

10. The image forming method for an image forming apparatus as set forth in claim 8, further comprising the steps of:
storing, in correspondence to the amounts of toners held by said developing units, rotation control modes capable of preventing the generation of vibration of said rotary unit when said rotary unit is switched from uniform rotation to deceleration rotation;
detecting the amounts of toners held by said developing units when said rotary unit is switched from uniform rotation to deceleration rotation; and
controlling the rotation of said rotary unit in accordance with a rotation control mode of said rotary unit stored corresponding to the amounts of toners held by said developing units thus detected.

11. The image forming method for an image forming apparatus as set forth in claim 8, wherein said rotation control modes stored in advance include at least either one of an acceleration, a uniform speed and a deceleration.

12. An image forming program for an image forming apparatus that serves to make a computer of said image forming apparatus execute an image forming method for driving a rotary unit with developing units for respective colors mounted thereon to rotate so as to sequentially stop said respective developing units at a position of development to perform development,
said program making said computer of said image forming apparatus execute:
storing, in correspondence to the amounts of toners held by said developing units, rotation control modes capable of preventing the generation of vibration of said rotary unit when the state of the rotational movement of said rotary unit is switched;
detecting the amounts of toners held by said developing units when the state of the rotational movement of said rotary unit is switched; and
controlling the rotation of said rotary unit in accordance with a rotation control mode of said rotary unit stored corresponding to the amounts of toners held by said developing units thus detected.
